(19) United States
(12) Patent Application Publication
(10) Pub. No.: US 2016/0291803 A1
(43) Pub. Date: Oct. 6, 2016

(54) INFORMATION PROCESSING APPARATUS AND STORAGE SYSTEM

(71) Applicant: FUJITSU LIMITED, Kawasaki-shi (JP)

(72) Inventors: Akira YAMAZAKI, Machida (JP); Takahiro YUMOTO, Nagano (JP)

(73) Assignee: FUJITSU LIMITED, Kawasaki-shi (JP)

(21) Appl. No.: 15/079,419

(22) Filed: Mar. 24, 2016

(30) Foreign Application Priority Data
Apr. 2, 2015 (JP) 2015-075524

(51) Int. Cl. G06F 3/0481

(52) U.S. Cl. CPC G06F 3/0481

(57) ABSTRACT

An information processing apparatus includes a storage unit, a control unit, and a display control unit. The storage unit stores relation information. The control unit compares first information with second information, and determines whether or not to update the second information. The control unit, when having determined to update the second information, updates the second information based on the first information and the relation information to generate update information. The control unit notifies the display control unit of the update information.

### CROSS-REFERENCE TO RELATED APPLICATION

This application is based upon and claims the benefit of priority of the prior Japanese Patent Application No. 2015-075524, filed on Apr. 2, 2015, the entire contents of which are incorporated herein by reference.

### FIELD

The embodiments discussed herein relate to an information processing apparatus and a storage system.

### BACKGROUND

When operating a storage device, the administrator performs a status check of the storage device, or a setting operation on the storage device. The administrator's tasks are performed using a Web GUI (Graphic User Interface). The Web GUI is a user interface which is displayed by a Web browser to facilitate setting or maintenance of the storage device, and information gathering.

Using an automatic re-read function of the Web browser provided in the Web GUI, or a re-read function of the Web browser by manual operation (manual re-read function), the administrator may obtain the status of the storage device at the time of re-read.

See, for example, Japanese Laid-open Patent Publication No. 2005-327089, Japanese National Publication of International Patent Application No. 2011-517346, and Japanese Laid-open Patent Publication No. 2006-331392.

However, the automatic re-read function is triggered by monitoring a time-out, and the manual re-read function is triggered by clicking a “re-read button” on the Web browser.

Therefore, the Web browser is not capable of obtaining the status of the storage device (device being monitored) without a re-read instruction. Accordingly, the status of the storage device being displayed by the Web browser will not be updated unless a re-read instruction is issued. In other words, even when the status of the storage device has changed, the Web browser is not capable of immediately reflecting the updated content on the display.

In order to reflect the updated content on the display immediately, the time-out period needs to be shortened as much as possible for the automatic re-read function, whereas frequent clicking on the “re-read button” is needed for the manual re-read function.

Frequent re-reading results in an excessive number of communications between the Web browser and the storage device, increases the processing load on the storage device, and adversely affects the performance of the storage device such as drop of throughput.

### SUMMARY

According to an aspect, there is provided an information processing apparatus which includes: a memory configured to store relation information indicating a relationship between first information with regard to a status of a device being monitored and second information with regard to a display content of a display device that displays the status of the device being monitored; and a processor configured to perform a procedure including: determining whether or not to update the second information, based on the first information obtained from the device being monitored and the second information obtained from a display control unit that performs display control of the display device; generating, when having determined to update the second information, update information obtained by updating the second information based on the obtained first information and the relation information; and notifying the display control unit of the update information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of an information processing system of a first embodiment;

FIG. 2 illustrates an exemplary configuration of a storage system of a second embodiment;

FIG. 3 illustrates an exemplary hardware configuration of a host computer of the second embodiment;

FIG. 4 illustrates an exemplary hardware configuration of a storage device of the second embodiment;

FIG. 5 illustrates an exemplary update sequence of a relation table of the second embodiment;

FIG. 6 illustrates an exemplary HTML document of the second embodiment;

FIG. 7 illustrates an exemplary SNIA class table of the second embodiment;

FIG. 8 illustrates an exemplary SMI-S response of the second embodiment;

FIG. 9 illustrates an exemplary relation table of the second embodiment;

FIG. 10 illustrates an exemplary updated relation table of the second embodiment;

FIG. 11 illustrates an exemplary update sequence of a display content of a Web browser of the second embodiment;

FIG. 12 illustrates an exemplary Indication notification of the second embodiment (first half);

FIG. 13 illustrates an exemplary Indication notification of the second embodiment (second half);

FIG. 14 illustrates a flowchart of a relation table update procedure of the second embodiment;

FIG. 15 illustrates a flowchart of a browser update procedure of the second embodiment;

FIG. 16 illustrates an exemplary timing chart of updating the status of the storage device and updating the display content of the Web browser, when an update monitoring engine of the second embodiment notifies the Web browser of an HTML document; and

FIG. 17 illustrates an exemplary timing chart of updating the status of the storage device and updating the display content of the Web browser, when the update monitoring engine of the second embodiment notifies the Web browser of an update instruction.

### DESCRIPTION OF EMBODIMENTS

Several embodiments will be described below with reference to the accompanying drawings, wherein like reference numerals refer to like elements throughout.

### First Embodiment

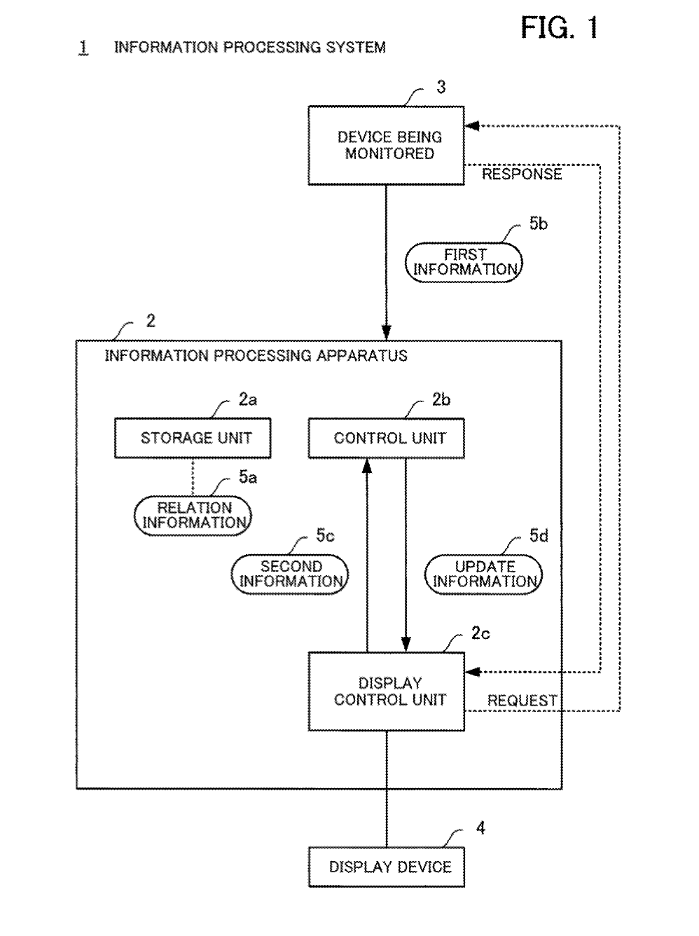

First, an information processing system of a first embodiment will be described referring to FIG. 1. FIG. 1 illustrates an exemplary configuration of the information processing system of the first embodiment.

An information processing system 1 includes an information processing apparatus 2, a device being monitored 3, and a display device 4. The device being monitored 3 is a device whose status is being monitored. The display device 4 displays the status of the device being monitored 3. The information processing apparatus 2 controls update of the display content displayed on the display device 4.

The information processing apparatus 2 includes a storage unit 2a, a control unit 2b, and a display control unit 2c. The storage unit 2a stores relation information 5a. The relation information 5a is information indicating the relationship between first information 5b and second information 5c. The first information 5b is information with regard to the status of the device being monitored 3. The second information 5c is information with regard to the display content of the display device 4 that displays the status of the device being monitored 3.

The relation information 5a includes information indicating the correspondence relation between a parameter included in the first information 5b and a parameter included in the second information 5c. In addition, the relation information 5a may be preliminarily set, or may be generated based on information (for example, the first information 5b, the second information 5c) obtained from both the device being monitored 3 and the display device 4 during operation thereof. In addition, the relation information 5a may be a combination of preliminarily set information and information generated during operation.

The control unit 2b compares the first information 5b with the second information 5c to determine whether or not to update the second information 5c. The control unit 2b obtains the first information 5b from the device being monitored 3, and obtains the second information 5c from the display control unit 2c. For example, the control unit 2b determines whether or not to update the second information 5c by determining whether the second information 5c obtained from the display control unit 2c corresponds to the first information 5b obtained from the device being monitored 3.

The display control unit 2c performs display control of the display device 4. For example, the display control unit 2c is a Web browser configured to generate a display content displayed on the display device 4.

Having determined to update the second information 5c, the control unit 2b generates update information 5d. The update information 5d is information obtained by updating the second information based on the first information 5b and the relation information 5a. The control unit 2b notifies the display control unit 2c of the update information 5d. The display control unit 2c updates the display control displayed on the display device 4 based on the update information 5d.

Accordingly, the information processing apparatus 2 allows the display control unit 2c to update the display control displayed on the display device 4.

As thus described, the information processing apparatus 2 determines whether or not to change the display, and allows the display device 4 to display the latest display content. Accordingly, the display control unit 2c need not frequently obtain the status and update the display content, which involve communication with the device being monitored 3 (requests from the display control unit 2c to the device being monitored 3, and responses from the device being monitored 3 to the display control unit 2c).

Therefore, the information processing apparatus contributes to reducing communication load and processing load of the device being monitored 3. In other words, the information processing apparatus 2 may suppress the adverse effect on the performance of the device being monitored 3. In addition, the administrator of the device being monitored 3 may quickly check the update of the status of the device being monitored 3 without frequently updating the display content. In addition, even when setting automatic update at a predetermined interval in place of performing update operation of the display content, the administrator of the device being monitored 3 may check the status of the device being monitored 3 without delay and without setting the automatic update period to be too short.

### Second Embodiment

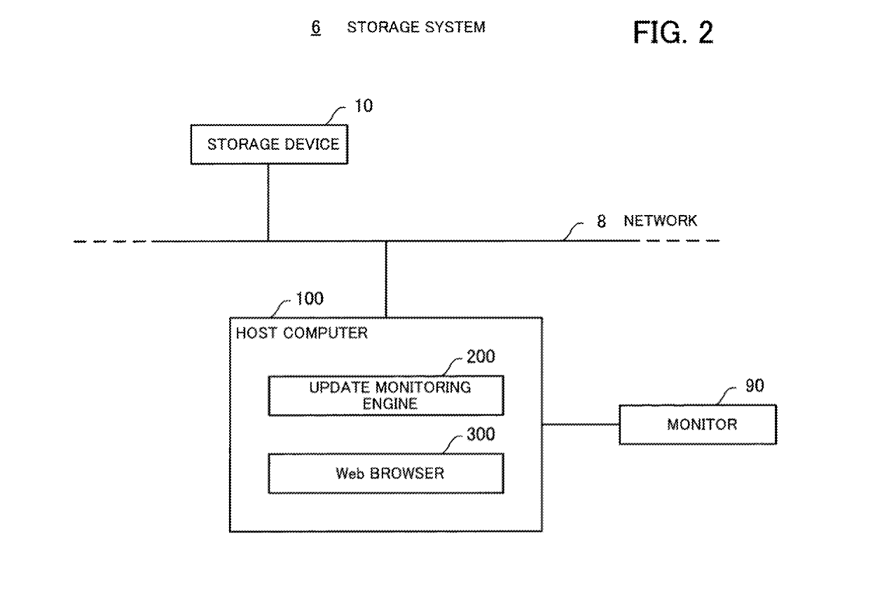

Next, a storage system of a second embodiment will be described, referring to FIG. 2. FIG. 2 illustrates an exemplary configuration of the storage system of the second embodiment.

A storage system 6 includes a storage device 10, a host computer 100, and a network (transmission path) 8. The network 8 communicatively connects the storage device 10 and the host computer 100. The host computer 100 monitors the status of the storage device 10. Therefore, the storage device 10 is a device being monitored by the host computer 100.

The host computer 100 includes an update monitoring engine 200 and a Web browser 300. The update monitoring engine 200 monitors the update of the display content displayed on a monitor 90 by the Web browser 300. The Web browser 300 displays, on the monitor 90, the status of the storage device 10 which is the device being monitored.

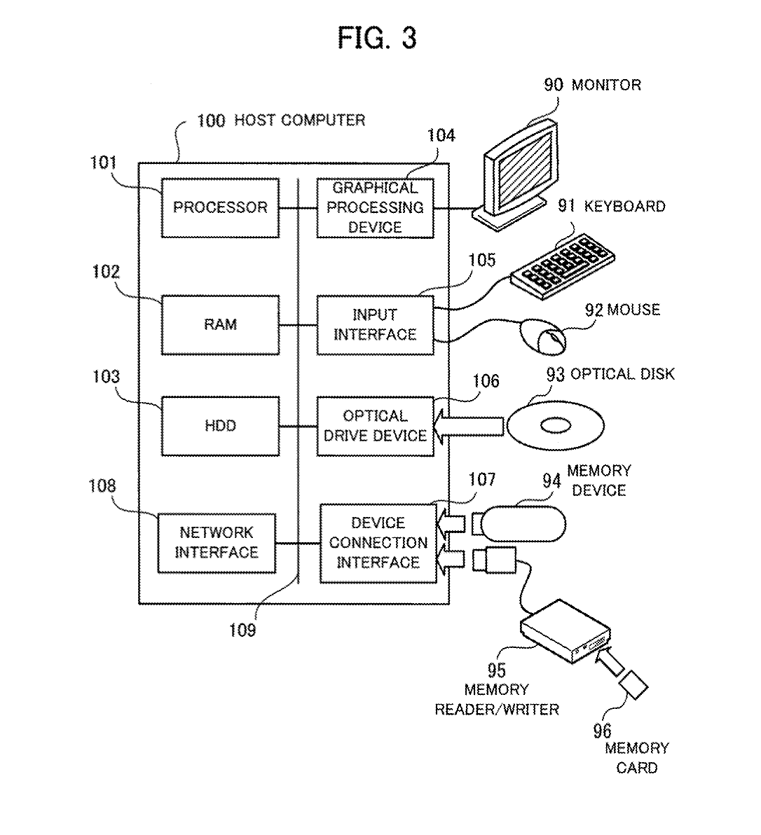

Next, a hardware configuration of the host computer 100 will be described, referring to FIG. 3. FIG. 3 illustrates an exemplary hardware configuration of a host computer of the second embodiment.

The host computer 100 is controlled in its entirety by a processor 101. In other words, the processor 101 functions as a control unit of the host computer 100. The processor 101 has a RAM (Random Access Memory) 102 and a plurality of peripheral devices connected thereto via a bus 109. The processor 101 may be a multiprocessor. The processor 101 is, for example, a CPU (Central Processing Unit), an MPU (Micro Processing Unit), a DSP (Digital Signal Processor), an ASIC (Application Specific Integrated Circuit), or a PLD (Programmable Logic Device). In addition, the processor 101 may be a combination of two or more elements of a CPU, an MPU, a DSP, an ASIC, and a PLD.

The RAM 102 is used as the main storage device of the host computer 100. The RAM 102 temporarily stores at least a part of the OS (Operating System) program or application programs to be executed on the processor 101. In addition, the RAM 102 stores a variety of data needed for processing by the processor 101.

Peripheral devices connected to the bus 109 include an HDD (Hard Disk Drive) 103, a graphical processing device 104, an input interface 105, an optical drive device 106, a device connection interface 107, and a network interface 108.

The HDD 103 magnetically writes and reads data to and from a built-in disk. The HDD 103 is used as an auxiliary storage device of the host computer 100. The HDD 103 stores the OS program, application programs, and a variety of data. A semiconductor storage device such as a flash memory may also be used as an auxiliary storage device.

The graphical processing device 104 has the monitor 90 connected thereto. The graphical processing device 104 displays images on the screen of the monitor 90 according to instructions from the processor 101. The monitor 90 may be a display device using a CRT (Cathode Ray Tube), or a liquid crystal display. The monitor 90 functions as a display device for displaying the status of the storage device 10.

The input interface 105 has a keyboard 91 and a mouse 92 connected thereto. The input interface 105 transmits to the processor 101 signals sent from the keyboard 91 or the mouse 92. The mouse 92 is an exemplary pointing device, and another pointing device may also be used. Another pointing device includes a touch panel, a tablet, a touchpad, a track ball, or the like.

The optical drive device 106 reads data stored on an optical disk 93, using laser beam or the like. The optical disk 93 is a portable storage medium having data stored thereon in a readable manner using reflection of light. The optical disk 93 includes a DVD (Digital Versatile Disc), a DVD-RAM, a CD-ROM (Compact Disc Read Only Memory), a CD-R (Recordable)/RW (ReWritable), or the like.

The device connection interface 107 is a communication interface for connecting peripheral devices to the host computer 100. For example, the device connection interface 107 may have a memory device 94 or a memory reader/writer 95 connected thereto. The memory device 94 is a storage medium having installed thereon a function to communicate with the device connection interface 107. The memory reader/writer 95 is a device for writing data to, or reading data from, a memory card 96. The memory card 96 is a card-type storage medium.

The network interface 108 is connected to the network 8. The network interface 108 transmits and receives data, via the network 8, to and from other computers including the storage device 10, or communication devices.

The processing function of the second embodiment may be realized by a hardware configuration such as that described above. For example, the update monitoring engine 200 and the Web browser 300 are realized by the processor 101 executing predetermined programs, respectively. The information processing apparatus 2 and the device being monitored 3 described in the first embodiment may also be realized with a hardware configuration similar to that of the host computer 100 illustrated in FIG. 3.

The host computer 100 realizes the processing function of the second embodiment by executing, for example, a program stored on a computer-readable storage medium. The program having described therein the processing content to be performed by the host computer 100 may be stored on a variety of storage media. For example, the program to be executed by the host computer 100 may be stored in the HDD 103. The processor 101 loads, to the RAM 102, at least a part of the program in the HDD 103, and executes the program. In addition, program to be executed by the host computer 100 may be stored in a portable storage medium such as the optical disk 93, the memory device 94, the memory card 96, or the like. The program stored in portable storage medium is installed in the HDD 103 and thereafter becomes executable by control from the processor 101, for example. In addition, the processor 101 may read and execute the program directly from the portable storage medium.

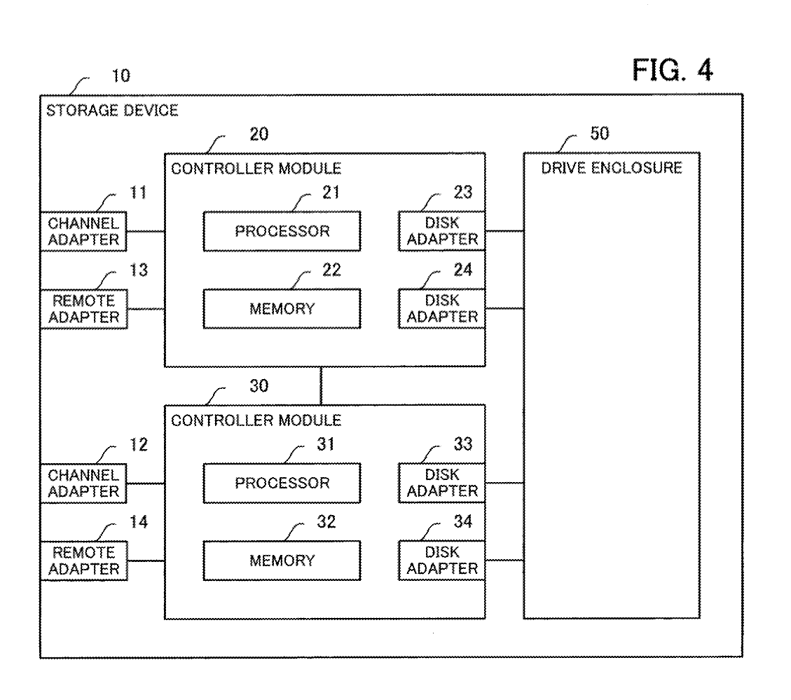

Next, a hardware configuration of a storage device of the second embodiment will be described, referring to FIG. 4. FIG. 4 illustrates an exemplary hardware configuration of the storage device of the second embodiment.

The storage device 10 includes channel adapters 11 and 12, remote adapters 13 and 14, controller modules (referred to as CM (Controller Module) in the following) 20 and 30, and a drive enclosure (referred to as DE (Drive Enclosure) in the following) 50.

The storage device 10 is connected to the host computer 100 via the channel adapters 11 and 12. The channel adapter 11 is provided corresponding to the CM 20, and the channel adapter 12 is provided corresponding to the CM 30. The storage device 10 may be connected to another storage device via the remote adapters 13 and 14. The remote adapter 13 is provided corresponding to the CM 20, and the remote adapter 14 is provided corresponding to the CM 30.

The DE 50 includes a plurality of HDDs. The DE 50 may include another storage device such as an SSD (Solid State Drive) in place of, or together with the HDD.

The CM 20 and the CM 30 may be connected to each other for load sharing. Although the storage device 10 includes two CMs 20 and 30, this is not limiting and the storage device 10 may include only one of the CM 20 and the CM 30, or may include three or more, for example, four or eight CMs.

The CM 20 includes a processor 21, a memory 22, and disk adapters 23 and 24. The CM 30 includes a processor 31, a memory 32, and disk adapters 33 and 34. Here, the CM 30 has a configuration similar to that of the CM 20, and therefore description of the CM 30 will be substituted by that of the CM 20, in the following.

The processor 21, the memory 22, and the disk adapters 23 and 24 are connected via a bus which is not illustrated. The processor 21, controlling the CM 20 in its entirety, performs storage control including hierarchical control. Here, the processor 21 may be a multiprocessor.

The memory 22 retains data which has been read from the HDD, and also functions as a buffer when writing data to the HDD. In addition, the memory 22 temporarily stores at least a part of the operating system program, the firmware, and application programs to be executed by the processor 21. In addition, the memory 22 has stored therein a variety of data needed for processing by the processor 21.

Peripheral devices to be connected to the bus include an input-output interface and a communication interface. The input-output interface is connected to the input-output device to perform input and output. The input-output interface transmits, to the processor 21 and the memory 22, signals and data sent from a storage device such as the HDD. In addition, the input-output interface outputs, for example, signals received from the processor 21 to another control unit, or an output device connected to the CM 20. The communication interface transmits and receives data to and from another CM (CM 30) in the storage device 10.

The disk adapters 23 and 24 perform interface control with the HDD.

The processing function of the storage device 10 or the CMs 20 and 30 may be realized by a hardware configuration such as that described above. The device being monitored 3 described in the first embodiment may also be realized by a hardware configuration similar to that of the storage device 10 or the CMs 20 and 30.

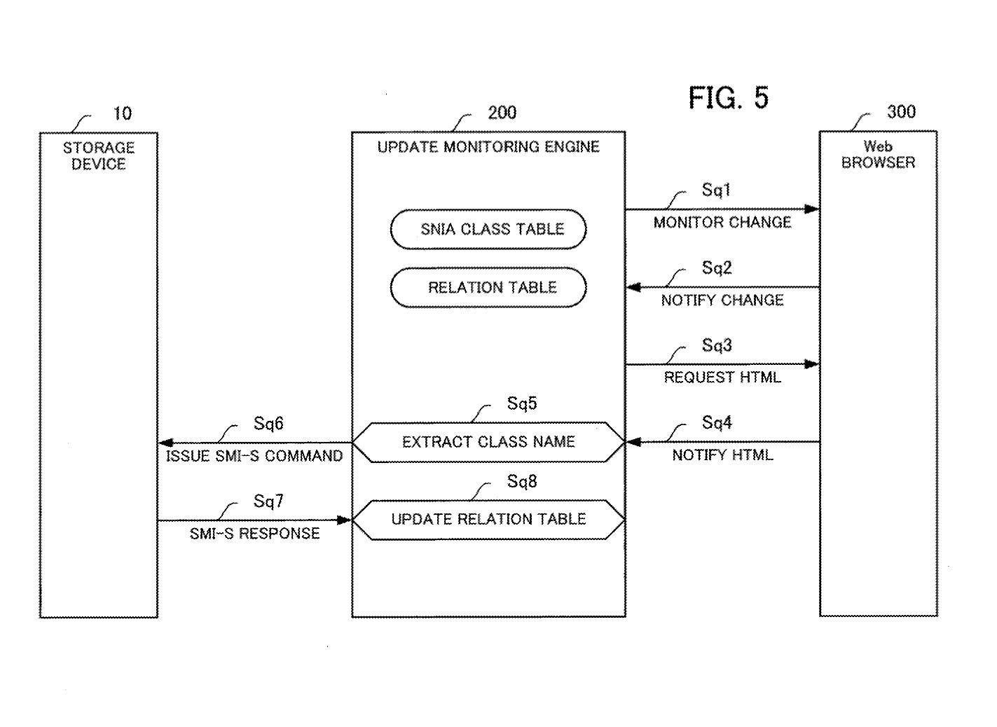

Next, update of the relation table managed by the update monitoring engine 200 will be described, referring to FIGS. 5 to 10. First, an update sequence of the relation table will be described, referring to FIG. 5. FIG. 5 illustrates an exemplary update sequence of a relation table of the second embodiment.

The update monitoring engine 200 holds an SNIA (Storage Networking Industry Association) class table and a relation table in a memory (RAM 102 or HDD 103). The SNIA class table and the relation table correspond to the relation information 5a of the first embodiment. The SNIA class table is information preliminarily set by the administrator or the like. The relation table is information to be generated and updated after the update monitoring engine 200 has been activated.

After having been activated, the update monitoring engine 200 collects predetermined information from the storage device 10 and the Web browser 300 and updates the relation table.

(Sequence Sq1) The update monitoring engine 200 monitors changes in the display content of the Web browser 300.

(Sequence Sq2) When there has been a change in the display content, the Web browser 300 notifies the update monitoring engine 200 of the change in the display content. The change in the display content of the Web browser 300 includes, for example, manually operated update, or automatic update at a predetermined period.

(Sequence Sq3) The update monitoring engine 200, upon receiving the notification of the change in the display content, requests for an HTML (HyperText Markup Language) document to the Web browser 300. The HTML document, which is information with regard to the display content displayed on the monitor 90 by the Web browser 300, corresponds to the second information 5c of the first embodiment.

(Sequence Sq4) The Web browser 300 notifies the update monitoring engine 200 of the HTML document.

(Sequence Sq5) The update monitoring engine 200 extracts, from the HTML document, the class name of the class conforming to the SNIA standard (referred to as SNIA class in the following). The SNIA standard is a standard relating to storage network technology. The SNIA standard includes classes based on the standard as a unified representation allowing a common recognition of the functions provided in the storage device without depending on the venders.

(Sequence Sq6) Specifying the extracted class name, the update monitoring engine 200 issues, to the storage device 10, an SMI-S (Storage Management Initiative-Specification) command requesting for a notification of the status of the storage device 10. SMI-S is a standard interface relating to the storage developed and maintained by the SNIA. The SMI-S command is a command conforming to SMI-S.

(Sequence Sq7) The storage device 10 notifies, in an SMI-S response, the update monitoring engine 200 of the status of the storage device 10.

(Sequence Sq8) The update monitoring engine 200 analyzes the relation between the SMI-S response and the HTML document, and updates the relation table according to the analysis result. After having updated the relation table, the update monitoring engine 200 returns to sequence Sq1 and monitors changes in the display content of the Web browser 300.

As thus described, the update monitoring engine 200 may hold the relation table in the latest state, each time the display content of the Web browser 300 is changed.

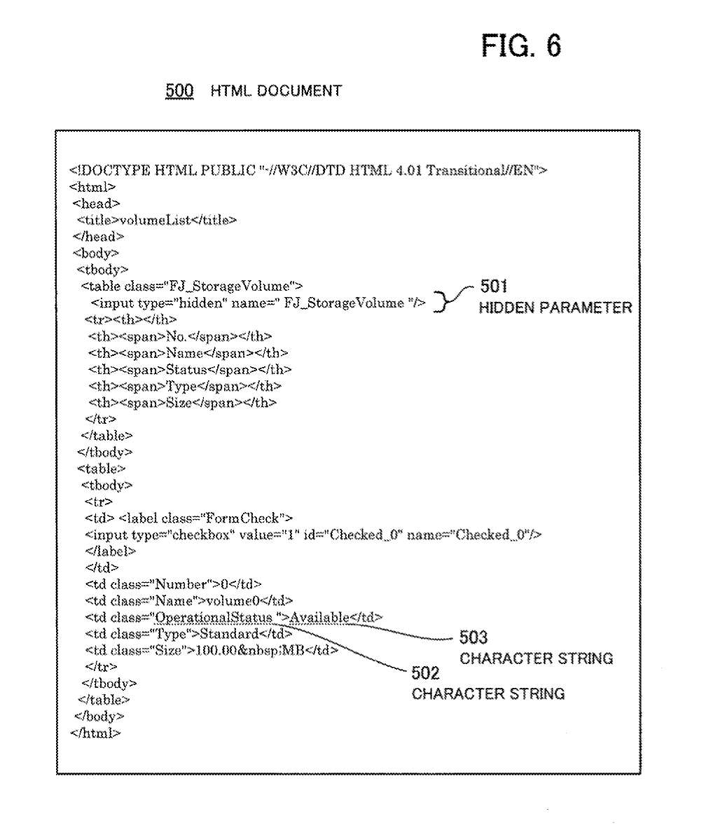

Next, an HTML document obtained from the Web browser 300 by the update monitoring engine 200 in sequence Sq4 will be described, referring to FIG. 6. FIG. 6 illustrates an exemplary HTML document of the second embodiment.

An HTML document 500 includes a hidden parameter 501 in the document. Setting the property of the <input> tag in the hidden parameter 501 to “hidden” makes a class name “FJ_StorageVolume” which is not displayed on the monitor 90 notifiable from the Web browser 300 to the update monitoring engine 200. When the class name is not requested to be non-display, i.e., when allowing the SNIA class name to be displayed on the monitor 90, the property of the <input> tag in the HTML document 500 need not necessarily be set to “hidden”.

Here, the class name is set by the Web GUI developer so as to be included in the HTML document. The class name in the HTML document is used as a header when analyzing the relationship between the HTML document and the SMI-S response. The relationship between the HTML document and the SMI-S response is predefined and registered in the SNIA class table by the Web GUI developer, for example.

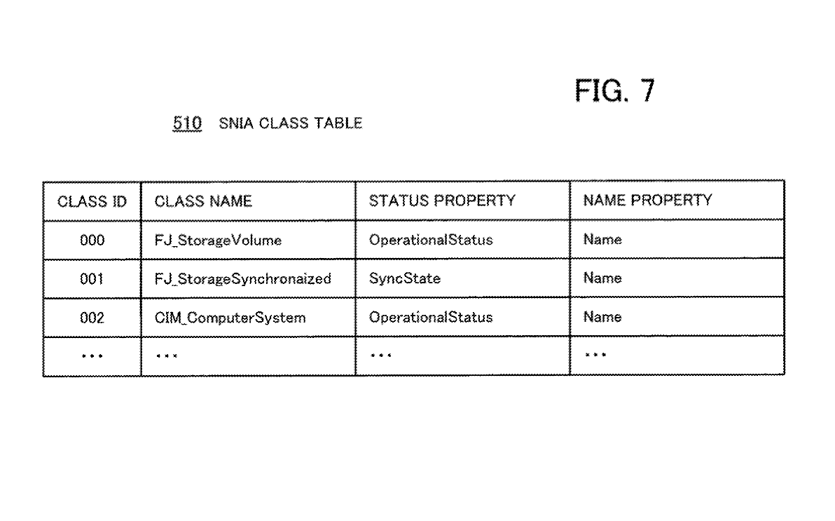

Next, an SNIA class table will be described, referring to FIG. 7. FIG. 7 illustrates an exemplary SNIA class table of the second embodiment.

An SNIA class table 510 is an exemplary SNIA class table held by the update monitoring engine 200. The SNIA class table 510 includes items of “class ID”, “class name”, “status property”, and “name property”.

The item “class ID (IDentification)” is identification information allowing an SNIA class registered with the SNIA class table 510 to be uniquely identified. The item “class name” is a name provided to an SNIA class. The item “status property” indicates the status property of an SNIA class, and the item “name property” indicates the name property of an SNIA class.

The SNIA class table 510 has a plurality of entries (class ID “000”, class ID “001”, class ID “002”, . . . ). For example, the SNIA class identified by the class ID “000” has the class name “FJ_StorageVolume”, a status property “OperationalStatus”, and a name property “Name”. The SNIA class identified by the class ID “001” has a class name “FJ_StorageSynchronaized”, a status property “SyncState”, and a name property “Name”. The SNIA class identified by the class ID “002” has a class name “CIM_ComputerSystem”, the status property “OperationalStatus”, and a name property “Name”.

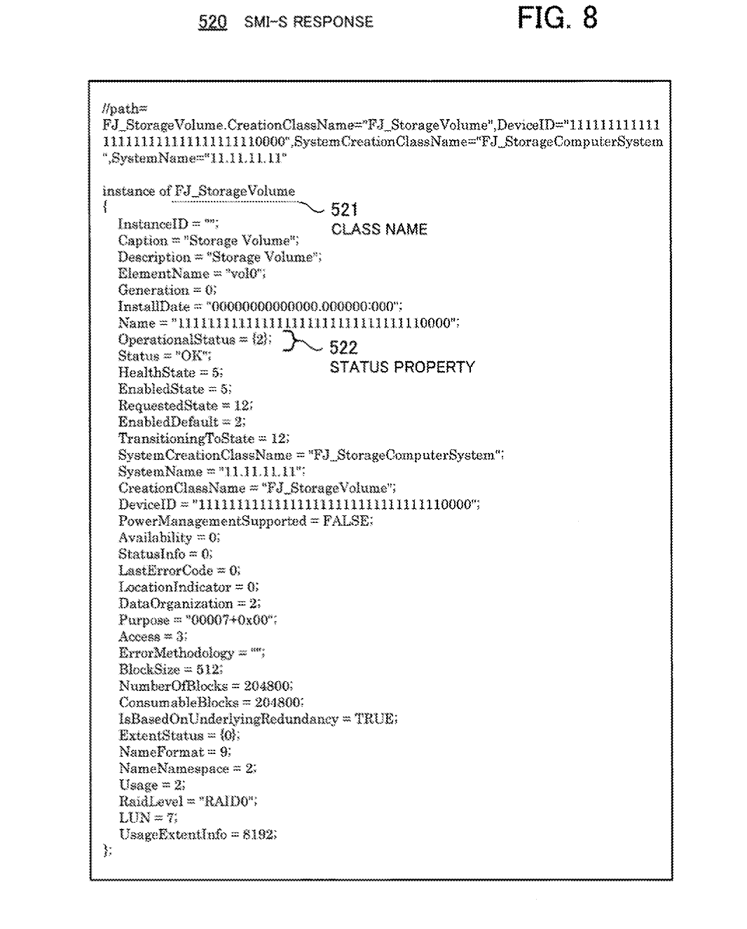

Next, an SMI-S response obtained from the storage device 10 by the update monitoring engine 200 in sequence Sq7 will be described, referring to FIG. 8. FIG. 8 illustrates an exemplary SMI-S response of the second embodiment.

An SMI-S response 520 is a response to an information acquisition request specifying the SNIA class (class name “FJ_StorageVolume”) extracted from the HTML document 500 by the update monitoring engine 200. The SMI-S response 520 includes a class name 521 and a status property 522. The class name 521 is the class name “FJ_StorageVolume”, indicating that the SMI-S response 520 is information of the SNIA class specified by the update monitoring engine 200. In addition, it may be seen that the status property of the class name “FJ_StorageVolume” is “OperationalStatus”, referring to the entry of the class ID “000” in the SNIA class table 510. The SMI-S response 520 includes a character string “OperationalStatus” and a value “2” as the status property of the class name “FJ_StorageVolume”. The character string “OperationalStatus” indicates the name of the status property, and the value indicates the information (status code) relating to the status of the storage device 10. The meaning of each value of the status code is defined by the SNIA standard as a parameter indicating the status of the SNIA class.

A Web GUI status may be used as information with regard to the display content of the Web browser 300. The Web GUI status, which is a character string uniquely defined by the Web GUI developer, is information with regard to the display content of the Web browser 300. Accordingly, it is impossible to grasp the correspondence relation between the Web GUI status and the status code immediately. Therefore, each time the update monitoring engine 200 analyzes a correspondence relation between the Web GUI status and the status code, the correspondence relation is registered in the relation table. The update monitoring engine 200 may refer to the analyzed correspondence relation from the relation table.

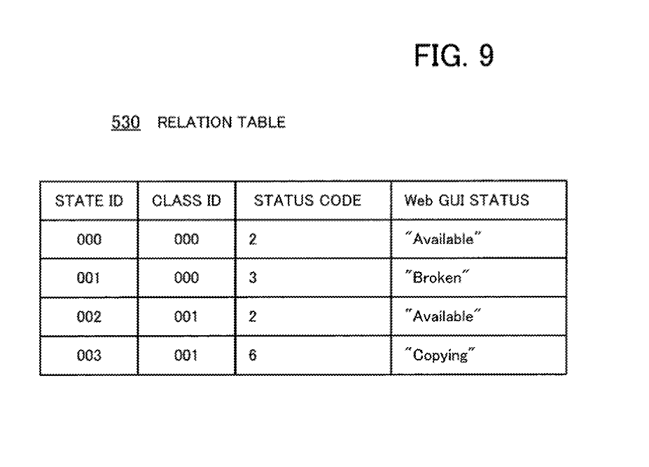

Next, a relation table will be described, referring to FIG. 9. FIG. 9 illustrates an exemplary relation table of the second embodiment.

A relation table 530 is an exemplary relation table held by the update monitoring engine 200. The relation table 530 includes items of “status ID”, “class ID”, “status code”, and “Web GUI status”.

The item “status ID” is identification information allowing a correspondence relation registered in the relation table 530 to be uniquely identified. The item “class ID” is identification information allowing an SNIA class to be uniquely identified. The item “status code” indicates the value of the status property of an SNIA class identified by the item “class ID”. The item “Web GUI status” indicates the Web GUI status corresponding to the status code of the SNIA class identified by the item “class ID”.

The relation table 530 has a plurality of entries (state ID “000”, state ID “001”, state ID “002”, and state ID 003). For example, a correspondence relation identified by the state ID “000” indicates that the Web GUI status corresponding to the status code “2” of the SNIA class identified by the class ID “000” is “Available”. A correspondence relation identified by the state ID “001” indicates that the Web GUI status corresponding to the status code “3” of the SNIA class identified by the class ID “000” is “Broken”. In addition, a correspondence relation identified by the state ID “002” indicates that the Web GUI status corresponding to the status code “2” of the SNIA class identified by the class ID “001” is “Available”. In addition, a correspondence relation identified by the state ID “003” indicates that the Web GUI status corresponding to the status code “6” of the SNIA class identified by the class ID “001” is “Copying”.

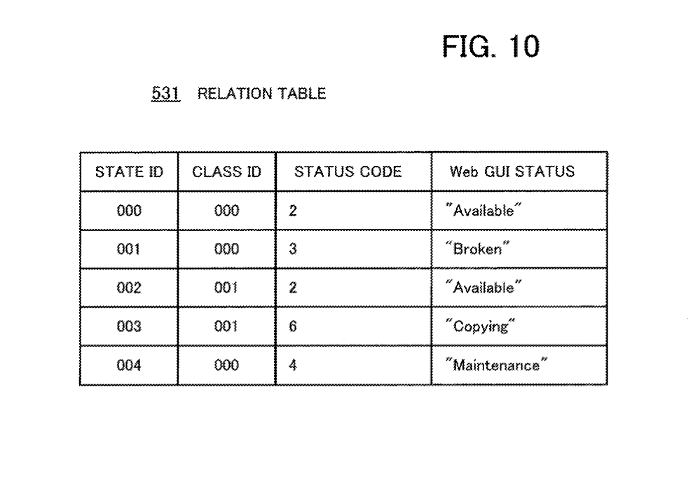

Note that the relation table 530, being automatically generated and updated by the update monitoring engine 200, grows larger as analysis results are accumulated. The updated relation table will be described, referring to FIG. 10. FIG. 10 illustrates an exemplary updated relation table of the second embodiment.

A relation table 531 is obtained by adding an entry of the state ID “004” to the relation table 530. For example, a correspondence relation identified by the state ID “004” indicates that the Web GUI status corresponding to the status code “4” of the SNIA class identified by the class ID “000” is “Maintenance”.

As thus described, the update monitoring engine 200 may enrich the relation table by being continuously activated. The relation table may be preliminarily set by the administrator or the like, based on known information.

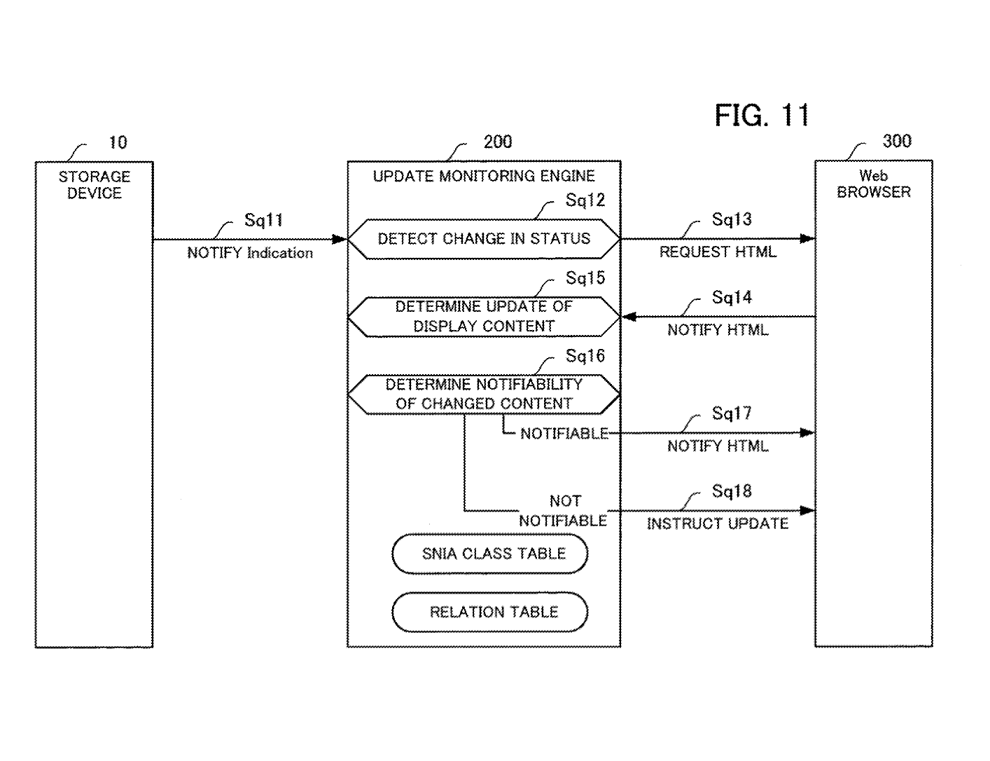

Next, the update of the display content of the Web browser 300, which the update monitoring engine 200 performs after determining whether or not to perform, will be described, referring to FIGS. 11 to 13. First, an update sequence of the display content of the Web browser 300, which the update monitoring engine 200 performs after determining whether or not to perform, will be described, referring to FIG. 11. FIG. 11 illustrates an exemplary update sequence of the display content of the Web browser of the second embodiment.

(Sequence Sq11) The storage device 10 has a function of notifying, when there has been a change in the status of the storage device 10, a specified address of the change in the status. This notification is referred to as an Indication notification. The storage device 10 may issue the Indication notification to the host computer 100 as the addressee.

(Sequence Sq12) The update monitoring engine 200 may detect a change in the status of the storage device 10 by receiving the Indication notification addressed to the host computer 100.

(Sequence Sq13) The update monitoring engine 200 requests, to the Web browser 300, for an HTML document corresponding to the display content.

(Sequence Sq14) The Web browser 300 notifies the update monitoring engine 200 of the HTML document corresponding to the display content.

(Sequence Sq15) The update monitoring engine 200 determines whether or not to update the display content of the Web browser 300. Whether or not to update the display content is determined by comparing the HTML document obtained from the Web browser 300 and the Indication notification received from the storage device 10. When it is determined that the update of the display content of the Web browser 300 is unnecessary, the update monitoring engine 200 waits for reception of the next Indication notification. When, on the other hand, it is determined to update the display content of the Web browser 300, the update monitoring engine 200 proceeds to sequence Sq16.

(Sequence Sq16) The update monitoring engine 200 determines whether or not the display content, which has been changed based on the Indication notification received from the storage device 10, is notifiable to the Web browser 300. Referring to the correspondence relation registered in the relation table, the update monitoring engine 200 determines that the display content is notifiable when the display content changed according to the Indication notification is generable, or determines that the changed display content is not notifiable when the changed display content is not generable.

(Sequence Sq17) Upon determining that the display content is notifiable, the update monitoring engine 200 notifies the Web browser 300 of the HTML document corresponding to the changed display content.

Accordingly, the Web browser 300 updates the display content immediately after the status of the storage device 10 is updated.

(Sequence Sq18) Upon determining that it is not notifiable, the update monitoring engine 200 instructs the Web browser 300 to update the display content. Upon receiving the update instruction, the Web browser 300 obtains information from the storage device 10, and updates the display content based on the obtained information.

Accordingly, the Web browser 300 updates the display content immediately after status of the storage device 10 is updated.

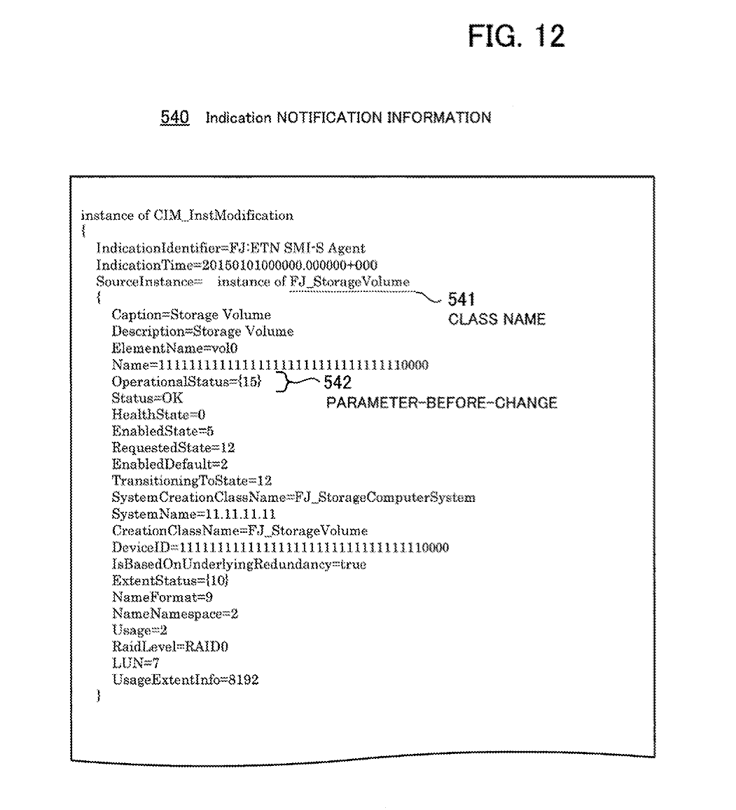

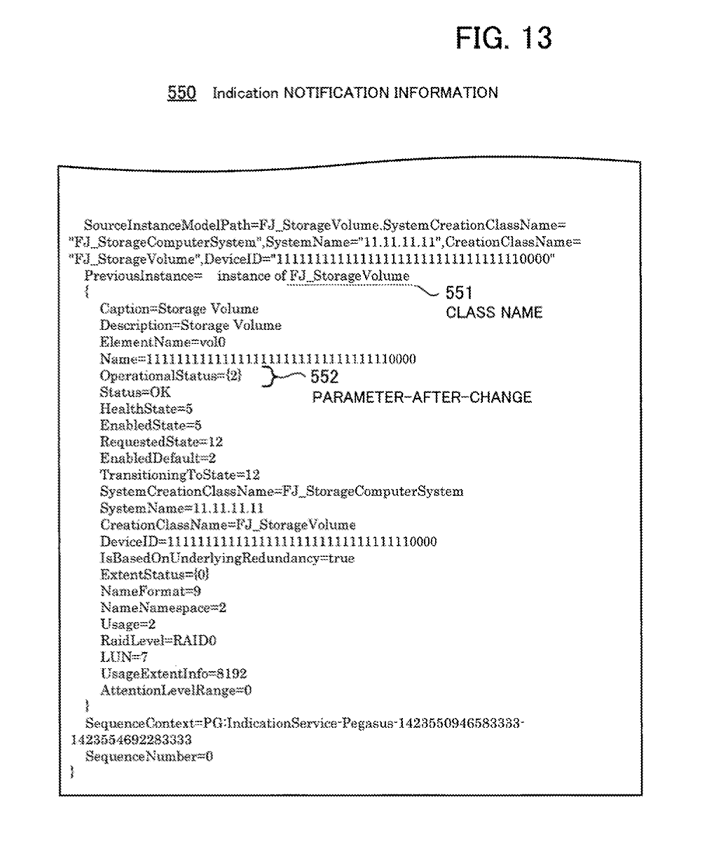

Next, an Indication notification obtained from the storage device 10 by the update monitoring engine 200 in sequence Sq11 will be described, referring to FIGS. 12 and 13. FIG. 12 illustrates an exemplary Indication notification of the second embodiment (first half). FIG. 13 illustrates an exemplary Indication notification of the second embodiment (second half).

Indication notification information 540 and Indication notification information 550 form single Indication notification, the Indication notification information 540 indicating the first half thereof, and the Indication notification information 550 indicating the second half thereof.

The Indication notification information 540 includes a parameter before the change in an SNIA class, and the Indication notification information 550 includes a parameter after the change in the SNIA class. Accordingly, the update monitoring engine 200 detects an SNIA class whose status has been changed, and parameters before and after the change.

For example, the Indication notification information 540 includes a class name 541 and a parameter-before-change 542. The class name 541 is a class name “FJ_StorageVolume” and its parameter-before-change 542 includes a character string “OperationalStatus” and a value “5” as the status property.

The Indication notification information 550 includes a class name 551 and a parameter-after-change 552. The class name 551 is a class name “FJ_StorageVolume”, and its parameter-after-change 552 includes a character string “OperationalStatus” and a value “2” as the status property.

In other words, the Indication notification information 540 and the Indication notification information 550 indicate that the value of the status property “OperationalStatus” has been updated from “5” to “2”, with regard to the SNIA class of the class name “FJ_StorageVolume”. As thus described, the update monitoring engine 200 detects a change in the status of the SNIA class from the Indication notification.

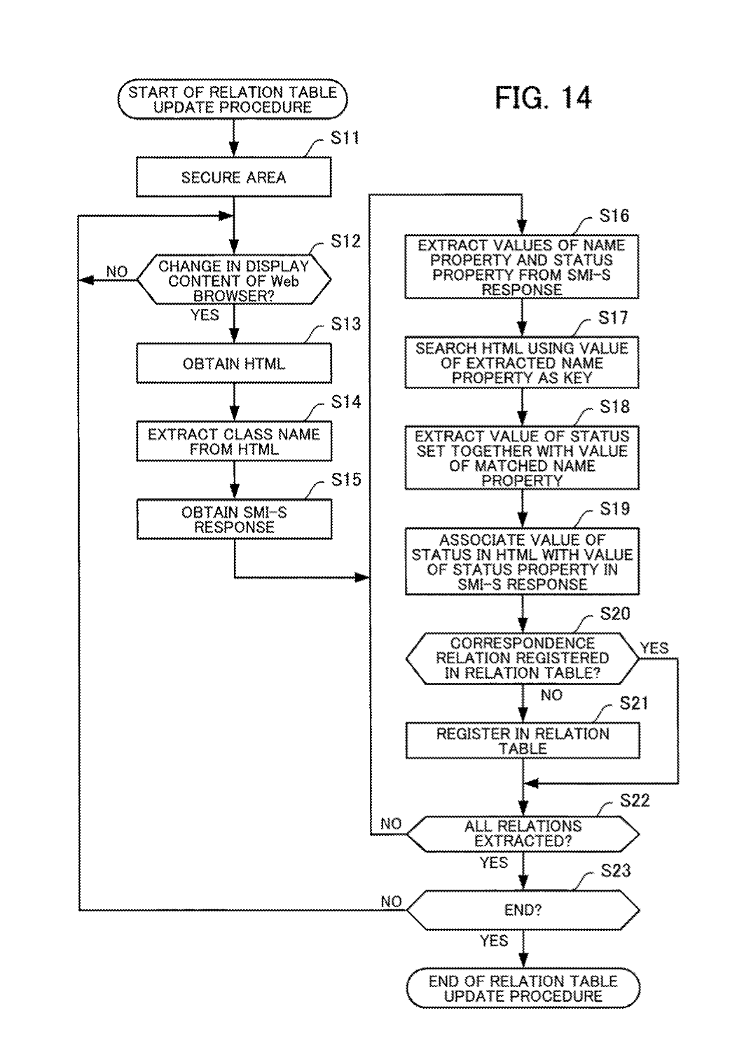

Next, a relation table update procedure will be described, referring to FIG. 14. The relation table update procedure is a process performed by the update monitoring engine 200 when updating the relation table which has been described referring to FIG. 5. FIG. 14 illustrates a flowchart of a relation table updating process of the second embodiment.

The relation table update procedure is a process triggered by activation of the update monitoring engine 200 and performed by the update monitoring engine 200.

(Step S11) The update monitoring engine 200 secures a storage area to be used for generating a relation table.

(Step S12) The update monitoring engine 200 monitors the display content of the Web browser 300, and determines whether or not there is a change in the display content. The update monitoring engine 200 detects, by a notification from the Web browser 300, that there has been a change in the display content. When there has been a change in the display content, the update monitoring engine 200 proceeds to step S13, or continues monitoring of the display content when there is no change in the display content.

(Step S13) The update monitoring engine 200 requests the Web browser 300 for an HTML document corresponding to the display content being displayed, and obtains the HTML document from the Web browser 300.

(Step S14) The update monitoring engine 200 extracts, from the HTML document, the class name conforming to the SNIA standard. The update monitoring engine 200 may extract “class name” from ‘name=“class name”’ in the search result by searching for a hidden parameter in the HTML document using a search key ‘type=“Hidden”’.

For example, the update monitoring engine 200 may extract a class name “FJ_StorageVolume” from the HTML document 500 (see FIG. 6).

(Step S15) Specifying the extracted class name, the update monitoring engine 200 issues an SMI-S command to the storage device 10. The update monitoring engine 200 obtains an SMI-S response as a response from the storage device 10 to the SMI-S command. Accordingly, the update monitoring engine 200 may obtain, from the storage device 10, information associated with the class specified in the extracted class name.

(Step S16) The update monitoring engine 200 extracts, from the SMI-S response, the value of the name property and the value of the status property.

For example, the update monitoring engine 200 extracts the value of the name property of a class name “FJ_StorageVolume” registered in the SNIA class table 510 (see FIG. 7) and the value of the status property, referring to the SMI-S response 520 (see FIG. 8). The status property 522 (see FIG. 8) includes a character string “OperationalStatus” and a value “2”, and therefore the update monitoring engine 200 may extract the value “2” as the status code of the status property “OperationalStatus”.

(Step S17) The update monitoring engine 200 searches the HTML document, using the value of the extracted name property as a key.

For example, the update monitoring engine 200 may detect a character string 502 from the HTML document 500, using the character string “OperationalStatus” as a search key.

(Step S18) The update monitoring engine 200 extracts, from the HTML document, the value of the status property which is set together with the value of the matched name property.

For example, the update monitoring engine 200 may extract, as the value of the status property, from the HTML document 500, a character string 503 (“Available”) which is set together with the character string 502.

(Step S19) The update monitoring engine 200 associates the value of the status property included in the HTML document extracted at step S18 with the value of the status property included in the SMI-S response extracted at step S16.

For example, the update monitoring engine 200 associates the character string “Available” extracted from the HTML document 500 with the status code “2” extracted from the SMI-S response 520.

(Step S20) The update monitoring engine 200 determines whether or not the correspondence relation associated at step S19 is already registered in the relation table. The update monitoring engine 200 proceeds to step S22 when the correspondence relation is already registered in the relation table, or proceeds to step S21 when the correspondence relation is not registered yet.

(Step S21) The update monitoring engine 200 registers, in the relation table, the correspondence relation associated at step S19.

(Step S22) The update monitoring engine 200 determines whether or not all the correspondence relations between the values of the status property included in the HTML document and the values of the status property included in the SMI-S response have been extracted. The update monitoring engine 200 proceeds to step S16 when not all the correspondence relations have been extracted, or proceeds to step S23 when all the correspondence relations have been extracted.

(Step S23) The update monitoring engine 200 determines whether or not a termination condition of the relation table updating process is satisfied. For example, termination of the update monitoring engine 200 is one of the termination conditions of the relation table updating process. The update monitoring engine 200 proceeds to step S12 when the termination condition is not satisfied, or terminates the relation table updating process when the termination condition is satisfied.

Accordingly, the update monitoring engine 200 may hold the relation table in its latest state each time the display content of the Web browser 300 is changed.

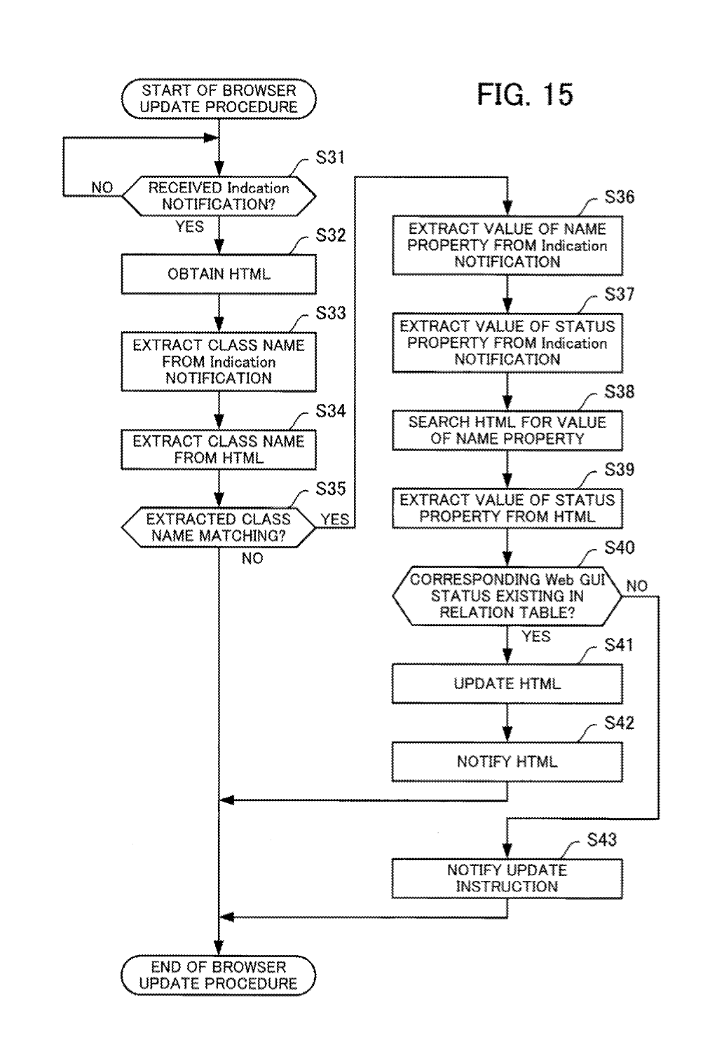

Next, a browser update procedure will be described, referring to FIG. 15. The browser update procedure is a process performed by the update monitoring engine 200 when updating the display content of the Web browser 300 described referring to FIG. 11. FIG. 15 illustrates a flowchart of the browser update procedure of the second embodiment.

The browser update procedure is a process triggered by activation of the update monitoring engine 200 and performed by the update monitoring engine 200. The update monitoring engine 200 performs the browser update procedure, with the relation table being held in the latest status by the relation table updating procedure.

(Step S31) The update monitoring engine 200 waits for an Indication notification to be notified from the storage device 10. Upon receiving the Indication notification, the update monitoring engine 200 proceeds to step S32.

(Step S32) The update monitoring engine 200 requests, to the Web browser 300, for an HTML document corresponding to the display content, and obtains the HTML document from the Web browser 300.

(Step S33) The update monitoring engine 200 extracts a class name conforming to the SNIA standard from the Indication notification. For example, the update monitoring engine 200 may extract the class name 541 (“FJ_StorageVolume)” in the item “SourceInstance” of the Indication notification (see FIG. 12).

(Step S34) The update monitoring engine 200 extracts, from the HTML document, a class name conforming to the SNIA standard. For example, the update monitoring engine 200 may search the HTML document 500 (see FIG. 6) using the search key ‘type=“hidden”’ and extract the class name “FJ_StorageVolume” from ‘name=“class name”’ existing in the search result.

(Step S35) The update monitoring engine 200 determines whether or not the class name extracted from the Indication notification matches the class name extracted from the HTML document. The update monitoring engine 200 proceeds to step S36 when the two extracted class names match with each other, or terminates the browser update procedure when they do not match.

A match between the two extracted class names indicates that the changed status in the storage device 10 is to be displayed by the Web browser 300. On the other hand, a mismatch between the two extracted class names indicates that the changed status in the storage device 10 is not to be displayed by the Web browser 300.

By performing the processes from steps S31 to S35, the update monitoring engine 200 functions as a screen change detection unit configured to detect whether or not to update the change in the screen of the Web browser 300.

(Step S36) The update monitoring engine 200 extracts the value of the name property from the Indication notification. For example, the update monitoring engine 200 extracts, from the Indication notification information 550 (see FIG. 13), the character string “OperationalStatus” included in the parameter-after-change 552.

(Step S37) The update monitoring engine 200 extracts the value (status code) of the status property from the Indication notification. For example, the update monitoring engine 200 extracts, from the Indication notification information 550 (see FIG. 13), the value “2” included in the parameter-after-change 552.

(Step S38) The update monitoring engine 200 searches the HTML document, using the value of the name property extracted from the Indication notification. For example, the update monitoring engine 200 may detect the character string 502 from the HTML document 500, using the character string “OperationalStatus” as the search key.

(Step S39) The update monitoring engine 200 extracts, from the HTML document, the value of the status property which is set together with the value of the matched name property. For example, the update monitoring engine 200 may extract, from the HTML document 500, the character string 503 (“Available”) which is set together with the character string 502, as the value of the status property.

(Step S40) The update monitoring engine 200 searches the relation table for a Web GUI status corresponding to the status code extracted at step S37. The update monitoring engine 200 proceeds to step S41 when the Web GUI status corresponding to the status code exists in the relation table, or proceeds to step S43 when it does not exist in the relation table.

According to the SNIA class table 510 (see FIG. 7), for example, the pair of the class name “FJ_StorageVolume” and the status property “OperationalStatus” belong to the class ID “000”. The update monitoring engine 200 searches the relation table 530 (see FIG. 9) for a Web GUI status corresponding to the status code “2” of the class ID “000”, and obtains the Web GUI status “Available”.

(Step S41) The update monitoring engine 200 updates the HTML document by replacing the Web GUI status in the HTML document obtained at step S32 with the Web GUI status obtained at step S40.

When, for example, the Web GUI status in the HTML document obtained at step S32 is “Broken”, the update monitoring engine 200 updates the HTML document by replacing the Web GUI status “Broken” with the Web GUI status “Available”.

(Step S42) The update monitoring engine 200 notifies the Web browser 300 of the updated HTML document, and terminates the browser update procedure.

Accordingly, the Web browser 300 reflects the updated status of the storage device 10 to the display content, without depending on the automatic re-read function or the manual re-read function. In addition, the Web browser 300 needs only to communicate with the update monitoring engine 200 when updating the display content, without having to communicate with the storage device 10. Therefore, the storage device 10 may reduce the communication load which occurs between itself and the Web browser 300, thereby reducing the processing load.

(Step S43) The update monitoring engine 200 notifies the Web browser 300 of an update instruction, and terminates the browser update procedure. The update instruction is an instruction to update the display content using the re-read function because the display content of the Web browser 300 does not reflect the latest status of the storage device 10.

Accordingly, the Web browser 300 reflects the updated status of the storage device 10 to the display content, using the re-read function. Although communication with the storage device 10 is needed, the Web browser 300 updates the display content without delay from the status update of the storage device 10. In addition, the Web browser 300 is notified of the triggering of execution of the re-read function from the update monitoring engine 200, and therefore need not frequently perform interrogation of the status to the storage device 10, in other words, execution of the re-read function. Therefore, the storage device 10 may reduce the communication load which occurs between itself and the Web browser 300, thereby reducing the processing load.

By performing the processes from steps S36 to S43, the update monitoring engine 200 functions as a display content update unit configured to make the Web browser 300 update the display content.

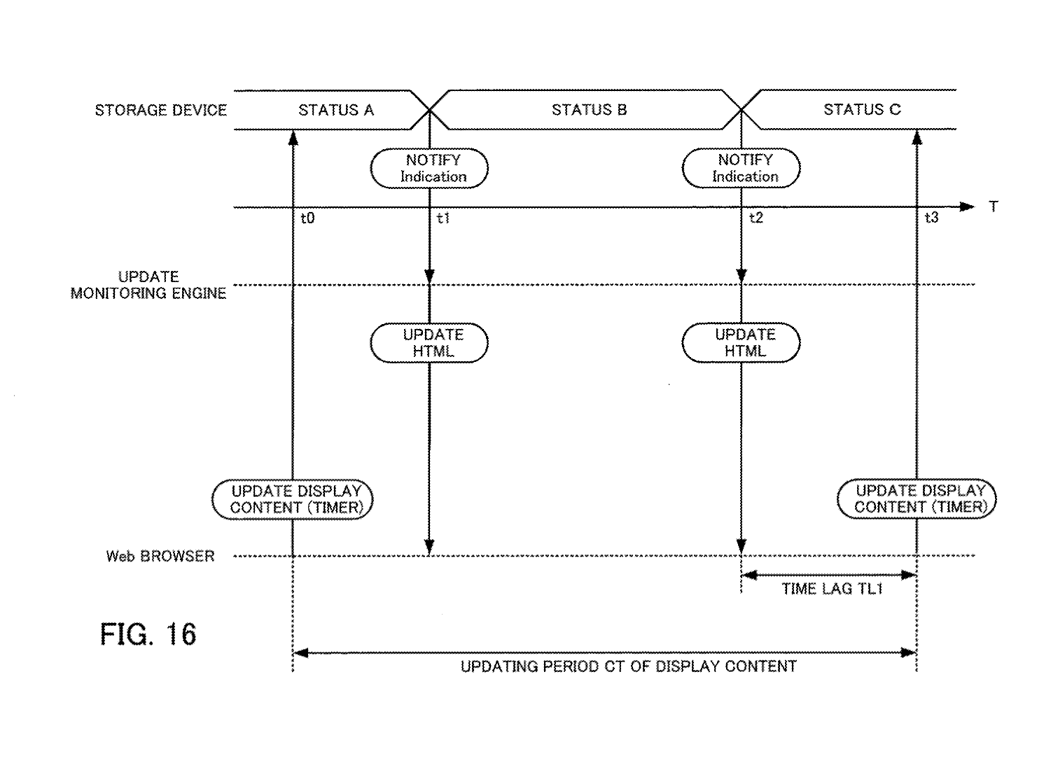

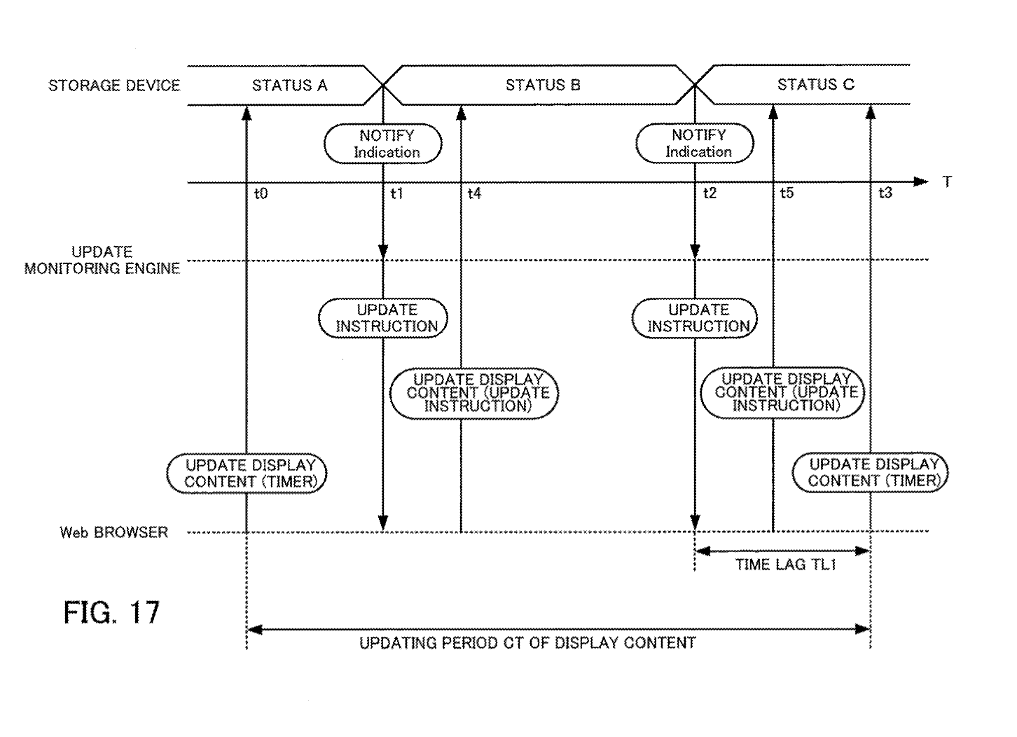

Next, the timing of updating the status of the storage device 10 and the timing of updating the display content of the Web browser 300 will be described, referring to FIGS. 16 and 17. First, the timing of updating the display content of the Web browser 300 when the update monitoring engine 200 notifies the Web browser 300 of the HTML document upon receiving an Indication notification from the storage device 10 will be described, referring to FIG. 16. FIG. 16 illustrates an exemplary timing chart of updating the status of the storage device and updating the display content of the Web browser when the update monitoring engine of the second embodiment notifies the Web browser of the HTML document.

When updating the display screen at an automatic update period CT, the Web browser 300 obtains information from the storage device 10 at timings t0 and t3. When, on this occasion, there are status updates in the storage device 10 from status A to status B at the timing t1, and from status B to status C at the timing t2, the Web browser 300 does not reflect, to the display content, the status update of the storage device 10 from the status A to the status B. In addition, the Web browser 300 reflects the status update of the storage device 10 from the status B to the status C to the display content at the timing t3, which has a time lag TL1 from the timing t2.

When, on the other hand, the update monitoring engine 200 notifies the Web browser 300 of the HTML document upon receiving an Indication notification from the storage device 10, the Web browser 300 reflects the status update of the storage device 10 to the display content without delay. In other words, the Web browser 300 displays the status B of the storage device 10 which is not displayed by the automatic re-read function. In addition, the Web browser 300 displays the status C of the storage device 10 without a time lag TL1 from the timing t2.

Next, the timing of updating the display content of the Web browser 300 when the update monitoring engine 200 notifies the Web browser 300 of an update instruction upon receiving an Indication notification from the storage device 10 will be described, referring to FIG. 17. FIG. 17 illustrates an exemplary timing chart of updating the status of the storage device and updating the display content of the Web browser, when the update monitoring engine of the second embodiment notifies the Web browser of the update instruction.

When the update monitoring engine 200 notifies the Web browser 300 of the update instruction upon receiving the Indication notification from the storage device 10, the Web browser 300 detects the status update of the storage device 10 without delay. The Web browser 300, when having received the update instruction at the timing t1, updates the display content at the timing t4. In addition, the Web browser 300, when having received the update instruction at the timing t2, updates the display content at the timing t5. In other words, the Web browser 300 displays the status B of the storage device 10 which is not displayed by the automatic re-read function. In addition, the Web browser 300 displays the status C of the storage device 10 without a time lag TL1 from the timing t2.

As thus described, the Web browser 300 reflects the status update of the storage device 10 to the display without delay, and therefore it is possible to suppress accesses to the storage device 10 caused by the re-read function.

Therefore, the update monitoring engine 200 contributes to reduction of communication load and processing load of the storage device 10. In other words, the update monitoring engine 200 suppresses the adverse effect on the performance of the storage device 10. In addition, the administrator of the storage device 10 may immediately check the update of the status of the storage device 10, without frequently updating the display content. In addition, also when setting automatic update at a predetermined interval in place of performing the update operation of the display content, the administrator of the storage device 10 may check the status of the storage device 10 without delay without setting the automatic update period to be too short.

Although, it is assumed in the second embodiment that the host computer 100 has both the update monitoring engine 200 and the Web browser 300, the host computer 100 may have only one of them. In such a case, an information processing apparatus (for example, a management device) different from the host computer 100 may have the other one. For example, the host computer 100 may have the Web browser 300 and the management device may have the update monitoring engine 200. In addition, the host computer 100 may have the update monitoring engine 200, the management device may have the Web browser 300, and a monitor provided in the management device may display the status of the storage device 10.

In either form described above, it is possible to suppress communication between the storage device 10 and Web browser 300.

The update of the display content based on the update triggering instructed from the update monitoring engine 200 may shorten the delay time from the status update of the storage device 10 to the update of the display content by comparing manual update in the Web browser 300 and automatic update at a predetermined period. Therefore, the update monitoring engine 200 need not frequently obtain information from the storage device 10. Accordingly, the update monitoring engine 200 may suppress the communication load on the storage device 10.

The aforementioned processing function may be realized by a computer. In such a case, there is provided a program having described therein the processing content of the functions to be included in the information processing apparatus 2 and the host computer 100 of the first embodiment. The aforementioned processing functions are realized on a computer by executing the program by the computer. The program having described therein the processing content may be stored on a computer-readable storage medium. There may be used, as a computer-readable storage medium, a magnetic storage device, an optical disk, a magneto-optical storage media, a semiconductor memory, or the like. There may be used, as a magnetic storage device, a hard disk drive (HDD), a flexible disk (FD), a magnetic tape, or the like. There may be used, as an optical disk, a DVD, a DVD-RAM, a CD-ROM/RW, or the like. There may be used, as a magneto-optical storage medium, an MO (Magneto-Optical disk), or the like.

When distributing a program, a portable storage medium such as, for example, a DVD or a CD-ROM having the program stored thereon is put in the market. In addition, the program may also be stored in the storage device of a server computer and transferred from the server computer to other computers via a network.

A computer expected to execute a program stores, in a storage device provided therein, the program stored on a portable storage medium or transferred from a server computer, for example. The computer then reads the program from the storage device provided therein and performs processing according to the program. The computer may also read the program directly from the portable storage medium and perform processing according to the program. In addition, the computer may also sequentially perform processing, each time a program is transferred from a server computer connected via a network, according to the received program.

In addition, at least a part of the aforementioned processing function may be realized by an electronic circuit such as a DSP, an ASIC, or a PLD.

According to an aspect, in an information processing apparatus, an information update program, and a storage system, the status of a device being monitored may be checked without delay, while suppressing the adverse effect on the performance of the device being monitored.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store relation information indicating a relationship between first information with regard to a status of a device being monitored and second information with regard to a display content of a display device that displays the status of the device being monitored; and
a processor configured to perform a procedure including:
determining whether or not to update the second information, based on the first information obtained from the device being monitored and the second information obtained from a display control unit that performs display control of the display device;
generating, when having determined to update the second information, update information obtained by updating the second information based on the obtained first information and the relation information; and
notifying the display control unit of the update information.

2. The information processing apparatus according to claim 1, wherein the procedure further includes instructing the display control unit to update the display content when the update information is not generable.

3. The information processing apparatus according to claim 1, wherein
the relation information includes information indicating correspondence relation between a first parameter included in the first information and a second parameter included in the second information, and
the procedure further includes updating the second information with the second parameter corresponding to the first parameter included in the first information to generate the update information.

4. The information processing apparatus according to claim 1, wherein the procedure further includes obtaining the first information when the status of the device being monitored is updated, and obtaining the second information from the display control unit after obtaining the first information.

5. The information processing apparatus according to claim 1, wherein
the first information and the second information include a third parameter with regard to information which is not displayed on the display device, and
the procedure further includes associating the first parameter with the second parameter via the third parameter.

6. The information processing apparatus according to claim 5, wherein the procedure further includes determining to update the second information when the third parameter extracted from the first information and the third parameter extracted from the second information match with each other.

7. A non-transitory computer-readable storage medium storing an information update program that causes a computer to perform a procedure comprising:
obtaining first information with regard to a status of a device being monitored from the device being monitored;
obtaining second information with regard to a display content of a display device that displays the status of the device being monitored, from a display control unit that performs display control of the display device;
determining whether or not to update the second information, based on the first information and the second information;
generating, when having determined to update the second information, update information obtained by updating the second information based on relation information indicating a relationship between the first information and the second information and the obtained first information; and
notifying the display control unit of the update information.

8. A storage system comprising a storage device to be monitored, a display device that displays a status of the storage device, and an information processing apparatus that monitors a display content of the display device, wherein
the information processing apparatus includes:
a memory configured to store relation information indicating a relationship between first information with regard to a status of the storage device and second information with regard to the display content; and
a processor configured to perform a procedure including:
determining whether or not to update the second information, based on the first information obtained from the storage device and the second information obtained from a display control unit that performs display control of the display device;
generating, when having determined to update the second information, update information obtained by updating the second information based on the obtained first information and the relation information; and
notifying the display control unit of the update information.
